(19) United States
(12) Patent Application Publication
(10) Pub. No.: US 2024/0330488 A1
(43) Pub. Date: Oct. 3, 2024

(54) TRANSMISSION APPARATUS, PROCESSING APPARATUS, TRANSMISSION METHOD, AND PROCESSING METHOD

(71) Applicant: CANON KABUSHIKI KAISHA, Tokyo (JP)

(72) Inventor: Takayuki Kaneko, Tokyo (JP)

(21) Appl. No.: 18/619,503

(22) Filed: Mar. 28, 2024

(30) Foreign Application Priority Data
Apr. 3, 2023 (JP) 2023-060440

(51) Int. Cl. G06F 21/60; G06F 3/12

(52) U.S. Cl. CPC G06F 21/608; G06F 3/1222; G06F 3/1238; G06F 3/1288; G06F 21/602

(57) ABSTRACT

A transmission apparatus for transmitting print data to a processing apparatus that processes the print data is provided. The transmission apparatus includes a decryption unit configured to generate plaintext data by decrypting encrypted data designated as a print target by a user, and a transmission unit configured to transmit the plaintext data to the processing apparatus as the print data, without transmitting the encrypted data to the processing apparatus.

### BACKGROUND OF THE INVENTION

### Field of the Invention

The present invention relates to a transmission apparatus, a processing apparatus, a transmission method, and a processing method.

### Description of the Related Art

Technology is known for generating print data without using printer drivers designed for using individual printing devices. Japanese Patent Laid-Open No. 2017-113904 describes a print client for performing printing based on a network protocol (IPP: Internet Printing Protocol) for causing a printing device to execute printing. The print client described in Japanese Patent Laid-Open No. 2017-113904 executes print processing in accordance with IPP communication procedures. Such print processing is also called IPP printing. IPP specifications are defined in RFC 2911 “Internet Printing Protocol/1.1: Model and Semantics”. Specifications of IPP extensions compatible with cloud-based infrastructure are defined in PWG 5100.12-2015 “IPP Shared Infrastructure Extensions (INFRA)”. When encrypted data (i.e., data that has been encrypted) is designated as the print target, such encrypted data is transmitted from a user device to a printing device as print data. If the printing device cannot decrypt the encrypted data, printing fails. If the reason for the printing failure can be recognized, the user device can convert the encrypted data into a raster image and re-execute printing. However, if the user device cannot recognize the reason for the printing failure, printing cannot be re-executed, and even if it were possible to re-execute the printing, it may take a long time to re-execute the printing.

### SUMMARY OF THE INVENTION

Some aspects of the present invention provide technology for efficiently executing the printing of encrypted data. According to some embodiments, a transmission apparatus for transmitting print data to a processing apparatus that processes the print data, the transmission apparatus comprising: a decryption unit configured to generate plaintext data by decrypting encrypted data designated as a print target by a user; and a transmission unit configured to transmit the plaintext data to the processing apparatus as the print data, without transmitting the encrypted data to the processing apparatus is provided.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of a printing system according to a first embodiment.

FIG. 2 is a block diagram illustrating an example of a hardware configuration of a printing device according to the first embodiment.

FIG. 3 is a block diagram illustrating an example of a software configuration of the printing device according to the first embodiment.

FIG. 4 is a block diagram illustrating an example of a hardware configuration of a computer according to the first embodiment.

FIG. 5 is a block diagram illustrating an example of a software configuration of a user device according to the first embodiment.

FIG. 6 is a schematic diagram illustrating an example of screens displayed by the user device according to the first embodiment.

FIG. 7 is a flowchart illustrating an example of operations of the user device according to the first embodiment.

FIG. 8 is a flowchart illustrating an example of operations of the user device according to the first embodiment.

FIG. 9 is a diagram illustrating an example of messages in the first embodiment.

FIG. 10 is a block diagram illustrating an example of a software configuration of a print server according to a second embodiment.

FIG. 11 is a flowchart illustrating an example of operations of the user device according to the second embodiment.

FIG. 12 is a diagram illustrating an example of messages in the second embodiment.

FIG. 13 is a flowchart illustrating an example of operations of a user device according to a third embodiment.

FIG. 14 is a diagram illustrating an example of messages in the third embodiment.

FIG. 15 is a flowchart illustrating an example of operations of a printing device according to the third embodiment.

FIG. 16 is a flowchart illustrating an example of operations of a user device according to a fourth embodiment.

FIG. 17 is a flowchart illustrating an example of operations of a user device according to a fifth embodiment.

FIG. 18 is a flowchart illustrating an example of operations of a printing device according to the fifth embodiment.

FIG. 19 is a diagram illustrating an example of messages in the fifth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

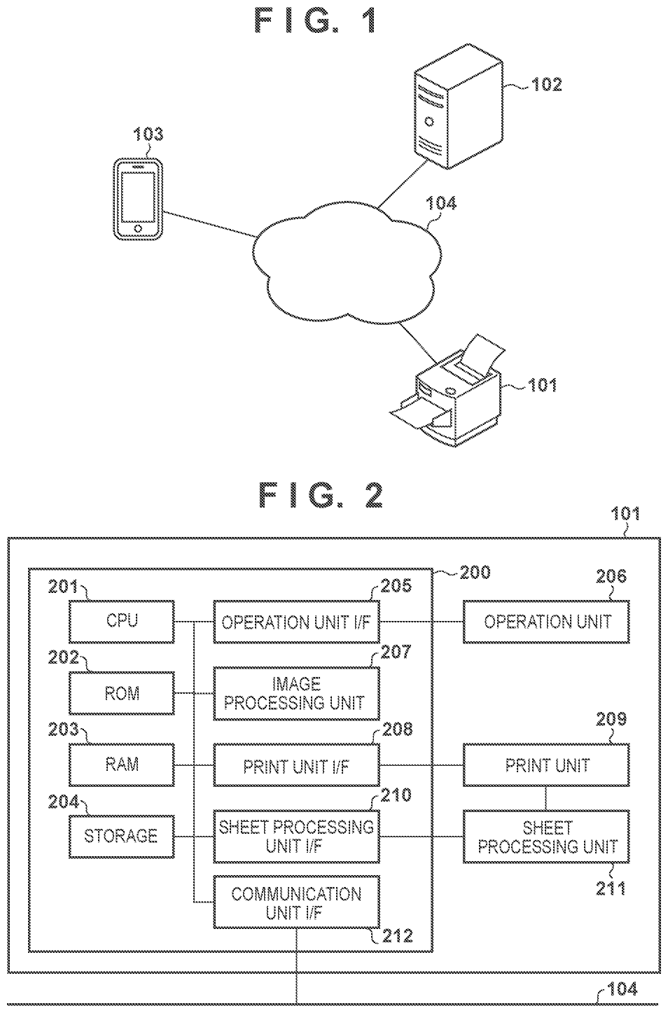

An example of the configuration of a printing system according to a first embodiment will be described below with reference to FIG. 1. The printing system according to the present embodiment may include a printing device 101, a print server 102, and a user device 103. In the example shown in FIG. 1, one printing device 101, one print server 102, and one user device 103 are shown, but the printing system may include multiple printing devices, multiple print servers, and multiple user devices.

The printing device 101, the print server 102, and the user device 103 can communicate via a network 104. The network 104 may be any network such as a local area network (LAN), a wide area network (WAN), a cellular network, or the Internet, or may include any combination thereof. The network 104 may include a wireless section, and may include a wired section. The network 104 may include an access point to which the user device 103 is wirelessly connected. This wireless connection may comply with the IEEE 802.11 series. Also, the user device 103 and the printing device 101 may be able to communicate with each other through direct wireless communication performed via an ad hoc network such as Wi-Fi Direct (registered trademark) or Wi-Fi Aware (registered trademark).

The printing device 101 is a device that executes printing based on a print job received from the print server 102 or the user device 103. The printing device 101 may be capable of processing print jobs that are compliant with IPP (Internet Printing Protocol). The printing device 101 may be a single-function printing device having only a printing function as its main function. Alternatively, the printing device 101 may be a multi-function printing device that has another main function (e.g., a scanning function or a copying function) other than the printing function. A multi-function printing device may also be called a multi-function peripheral (MFP).

The print server 102 provides a printing service using one or more printing devices including the printing device 101. In the case where the print server 102 is constructed in a cloud environment, the printing service provided by the print server 102 may be referred to as a cloud printing service. The print server 102 may be constructed in an on-premises environment.

The user device 103 is a device used by a user. The user device 103 may also be called a user terminal, a communication terminal, a communication device, a client device, a client terminal, an information processing apparatus, or the like. The user device 103 may be a smartphone, a tablet computer, a desktop computer, or a laptop computer, for example.

The user device 103 may have an IPP-compliant print client, and may be able to transmit print data to the printing device 101 or the print server 102 using a message defined in IPP. The user device 103 may be used by the user to use a printing service provided by the print server 102. For example, the user device 103 may transmit print data to the print server 102 in accordance with an instruction from the user. The print server 102 may transmit a print job to the printing device 101 in accordance with print data obtained from the user device 103. The user device 103 may be able to directly instruct the printing device 101 to perform printing (i.e., without going through the print server 102). In this case, the printing system may be considered to be constituted by the printing device 101 and the user device 103.

### Example of Hardware Configuration of Printing Device

An example of the hardware configuration of the printing device 101 will be described below with reference to FIG. 2. The printing device 101 may include the constituent elements shown in FIG. 2. The printing device 101 may not include some of the constituent elements shown in FIG. 2, and may include constituent elements not shown in FIG. 2.

A control unit 200, which includes a central processing unit (CPU) 201, performs overall control of the operation of the printing device 101. The CPU 201 reads a control program stored in a read only memory (ROM) 202 or a storage 204, and executes the control program to perform various types of control such as printing control and reading control. The ROM 202 stores control programs that can be executed by the CPU 201. A random access memory (RAM) 203 is the main storage memory of the CPU 201. The RAM 203 is used as a work area or a temporary storage area for the loading of various control programs. The storage 204 stores print job data, image data, various programs, and various types of setting information. The storage 204 may temporarily store print job data using a hold function. The storage 204 may be a magnetic storage device such as a hard disk drive (HDD), or may be a nonvolatile memory such as a solid state drive (SSD). In this way, pieces of hardware such as the CPU 201, the ROM 202, the RAM 203, and the storage 204 constitute a so-called computer.

In the printing device 101 of the present embodiment, one CPU 201 uses one memory (RAM 203) to execute the processing shown in later-described flowcharts. Alternatively, for example, the processing shown in the later-described flowcharts may be executed by cooperation between a plurality of CPUs, RAMs, ROMs, and storages. Also, at least part of the processing may be executed using a hardware circuit such as an application specific integrated circuit (ASIC) or a field-programmable gate array (FPGA).

An operation unit interface (I/F) 205 connects an operation unit 206 and the control unit 200 to each other. The operation unit 206 includes a liquid crystal display unit having a touch panel function and various hardware keys, for example. The operation unit 206 also functions as a display unit that displays information and a reception unit that receives user instructions.

An image processing unit 207 has a raster image processor (RIP) function that loads a print job and generates a print image used for printing. Furthermore, the image processing unit 207 may perform resolution conversion and correction processing on image data. The image processing unit 207 may be realized by a hardware circuit (e.g., an ASIC or an FPGA). Alternatively, for example, the printing device 101 may further include a processor for image processing, and that processor may execute an image processing program to realize image processing and processing for development into print data. In this case, the processor and the CPU 201 may operate in cooperation to execute later-described flowcharts. Furthermore, the CPU 201 may be configured to execute a program for performing image processing, and perform image processing and print data development processing. Also, image processing may be performed by any combination of such configurations.

A print unit I/F 208 connects a print unit 209 and the control unit 200 to each other. A print image generated by the image processing unit 207 is transferred from the control unit 200 to the print unit 209 via the print unit I/F 208. The print unit 209 receives a control command and the print image via the control unit 200, and prints an image on a sheet fed from a paper feed cassette (not shown), based on the print image. The printing method used by the print unit 209 may be an electrophotographic method, may be an inkjet method, or may be another printing method such as a thermal transfer method. A sheet processing unit I/F 210 connects a sheet processing unit 211 and the control unit 200 to each other. The sheet processing unit 211 receives a control command from the CPU 201, and performs post-processing on a sheet printed by the print unit 209, in accordance with the control command. For example, the sheet processing unit 211 executes post-processing such as arranging sheets, punching holes in sheets, and binding sheets. Also, the control unit 200 is connected to the network 104 via a communication unit I/F 212. The communication unit I/F 212 transmits capability information and status information to user devices on the network 104, and receives print jobs from user devices on the network 104.

### Example of Software Configuration of Printing Device

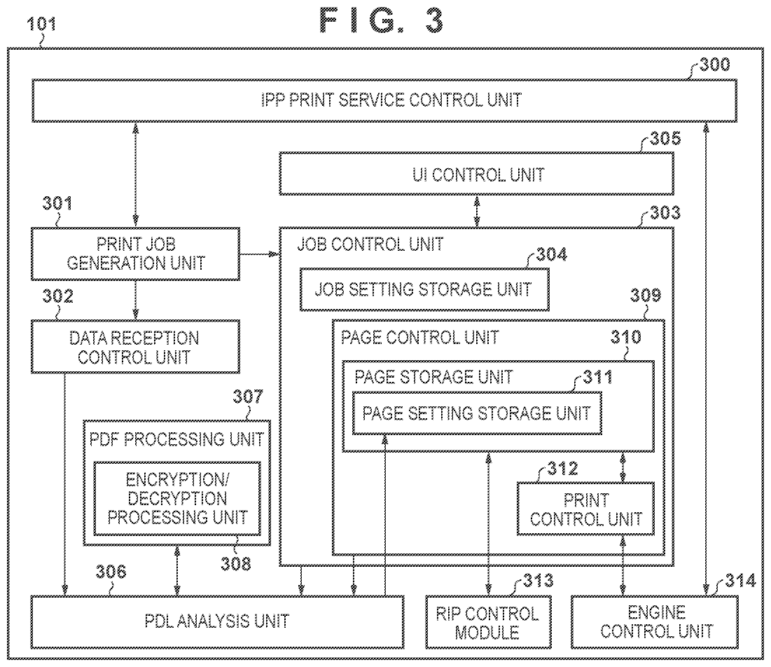

An example of the software configuration of the printing device 101 will be described below with reference to FIG. 3. The printing device 101 may include the constituent elements shown in FIG. 3. The printing device 101 may not include some of the constituent elements shown in FIG. 3, and may include constituent elements not shown in FIG. 3. The constituent elements (i.e., functional blocks) shown in FIG. 3 may be realized by the CPU 201 executing a program loaded to the RAM 203.

An IPP print service control unit 300 has a function of controlling communication with a client (e.g., the print server 102 or the user device 103) when performing IPP-related printing. The IPP print service control unit 300 has a function of receiving an inquiry regarding printing, and notifying attribute information indicating capabilities of the printing device 101. The attribute information includes information such as data formats that can be accepted and print job settings that can be accepted by the printing device 101. Examples of print job settings include compatible paper sizes and paper types, color and monochrome print modes, print side settings (e.g., single-sided/double-sided or N-up (combined printing)), and settings related to post-processing.

The following describes reception of a print job. Upon receiving a print job from a client, the IPP print service control unit 300 passes the print job to a print job generation unit 301. The print job generation unit 301 receives the print job via the IPP print service control unit 300 and writes rendering data to a data reception control unit 302. The print job generation unit 301 also registers the print job as a new job in a job control unit 303, and requests the start of print processing. Also, the print job generation unit 301 specifies print settings to be applied to the print job by analyzing the print job, and passes the print settings to a job setting storage unit 304. The job setting storage unit 304 stores setting information for a print job. The setting information may include “number of copies”, “N-up (combined printing)”, “print side (single-sided/double-sided) setting”, “color/monochrome mode”, “finishing setting”, and the like.

A user interface (UI) control unit 305 obtains information regarding the status of an in-processing print job from the job control unit 303, and displays a UI screen of the print job processing status on the operation unit 206.

The data reception control unit 302 is a reception buffer area for print jobs received by the print job generation unit 301, and temporarily stores the print jobs in the storage 204. When the job control unit 303 instructs a PDL analysis unit 306 to perform PDL analysis processing on a print job, the PDL analysis unit 306 requests the corresponding print job from the data reception control unit 302. Upon receiving the request, the data reception control unit 302 passes the data of the corresponding print job to the PDL analysis unit 306.

If the received print job data is encrypted data, the PDL analysis unit 306 requests an encryption/decryption processing unit 308 of a PDF processing unit 307 to decrypt the encrypted data. Such encrypted data is data that has been encrypted. A password associated with the encrypted data is required in order to decrypt the encrypted data. In the following description, encrypted PDF data will be treated as an example of the encrypted data. The encrypted PDF data may be data generated by encrypting plaintext PDF data. In the following description, data other than PDF data may also be encrypted.

The encryption/decryption processing unit 308 generates plaintext data by decrypting the encrypted data. Plaintext data is data that is not encrypted. Plaintext data generated by decrypting encrypted PDF data can also be called plaintext PDF data. The encryption/decryption processing unit 308 passes the plaintext PDF file obtained by decryption to the PDL analysis unit 306.

The job control unit 303 instructs the PDL analysis unit 306 to analyze the print job. The PDL analysis unit 306 generates page data, and a page control unit 309 stores image data for each page in a page storage unit 310 and stores print settings for each page in a page setting storage unit 311.

The page control unit 309 controls page analysis processing performed by the PDL analysis unit 306, RIP processing performed by a RIP control unit 313, and print control processing performed by a print control unit 312. The print control unit 312 obtains RIP-processed image data from the page storage unit 310, separates the data into CMYK, and transfers the data to an engine control unit 314. The engine control unit 314 receives the CMYK image data page by page from the print control unit 312, and controls the print unit 209 to perform print processing for each page.

### Example of Hardware Configuration of Computer

An example of the hardware configuration of a computer 400 will be described below with reference to FIG. 4. The computer 400 may be used as the print server 102, or may be used as the user device 103. The computer 400 may include the constituent elements shown in FIG. 4. The computer 400 may not include some of the constituent elements shown in FIG. 4, and may include constituent elements not shown in FIG. 4.

The CPU 401 performs overall control of the operation of the computer 400. The CPU 401 loads a program stored in the ROM 402 or the storage 404 to the RAM 403, and executes the program to perform various types of control such as print setting screen control, print data generation, and print job transfer. The ROM 402 stores control programs that can be executed by the CPU 401, as well as a boot program, for example. The RAM 403 is the main storage memory of the CPU 401. The RAM 403 is used as a work area or a temporary storage area for loading various programs. The storage 404 stores an operating system (OS), a print client, print data generated by the print client, and various types of setting information. The communication unit I/F 405 is a network interface by which data can be transmitted to and received from another device (e.g., the printing device 101) via the network 104.

The operation unit 407 is connected to the operation unit I/F 406. The operation unit 407 may include a display device that displays a print setting screen provided by the print client, and an input device that receives user operations. The display device and the input device may be integrated with each other in the form of a touch screen.

### Example of Software Configuration of User Device

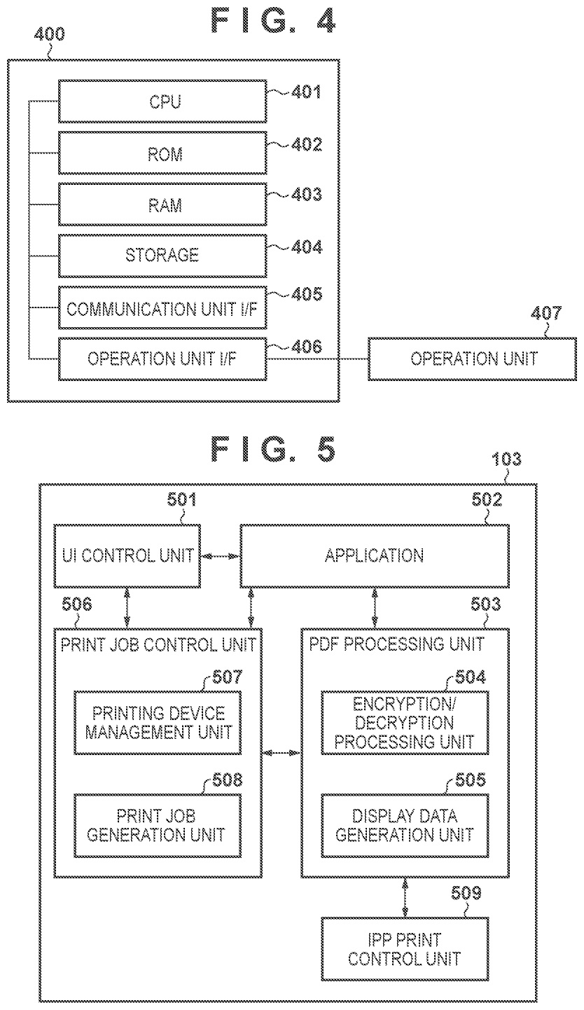

An example of the software configuration of the user device 103 will be described below with reference to FIG. 5. The user device 103 may include the constituent elements shown in FIG. 5. The user device 103 may not include some of the constituent elements shown in FIG. 5, and may include constituent elements not shown in FIG. 5. The constituent elements (i.e., functional blocks) shown in FIG. 5 may be realized by the CPU 401 of the user device 103 executing a program loaded to the RAM 403 of the user device 103.

A UI control unit 501 may have a function of interpreting a user operation received by the operation unit 407 of the user device 103. The UI control unit 501 may have a function of issuing a command to an application 502 and a print job control unit 506. The UI control unit 501 may have a function of displaying a notification from the application 502 or the print job control unit 506 on the operation unit 407 of the user device 103. The application 502 may be any application that receives a print instruction from the user. For example, the application 502 may be a browser, a PDF viewer, or the like.

The PDF processing unit 503 performs processing related to PDF data designated by a request from the application 502 or the print job control unit 506. An encryption/decryption processing unit 504 has a function of decrypting encrypted PDF data. A display data generation unit 505 has a function of generating display data that the application 502 or the print job control unit 506 displays on the operation unit 407 of the user device 103.

A print job control unit 506 may include a printing device management unit 507 and a print job generation unit 508. The printing device management unit 507 has functions of searching for the printing device 101, obtaining the capabilities of the printing device 101, and the like. The print job generation unit 508 has a function of generating a print job based on data designated by the application 502 in response to a request from the application 502. An IPP print service control unit 509 has a function of controlling communication performed with the printing device 101 or the print server 102 when performing IPP-related printing. The IPP print service control unit 509 may transmit a print job or may obtain a print job processing result.

### Example of Flow of Screens

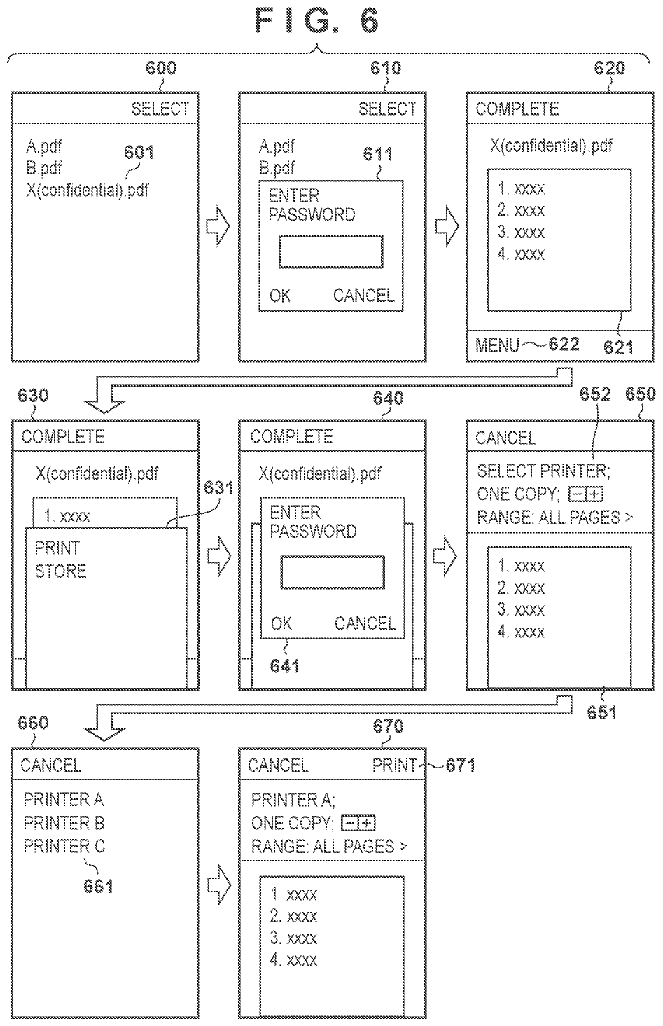

An example of screens displayed on the operation unit 407 of the user device 103 when the user uses the user device 103 to execute printing will be described below with reference to FIG. 6. A screen 600 is a file selection screen generated by the application 502. The screen 600 shows that three files can be selected and displayed. It is assumed that among these three files, a file 601 is encrypted PDF data. Therefore, a password needs to be input in order to view the file 601.

In response to the user selecting the file 601, the application 502 performs processing for displaying the file 601. Since the file 601 is encrypted, the application 502 displays a screen 610 that includes a password input screen 611.

In response to the user entering the password for the file 601 in the password input screen 611 and pressing the OK button, the application 502 generates plaintext data by decrypting the file 601 using the encryption/decryption processing unit 504. Subsequently, the application 502 uses the display data generation unit 505 to display a screen 620 that includes a raster image 621 showing the content of the plaintext data.

In response to the user selecting a menu button 622 on the screen 620, the application 502 displays a screen 630 that includes a menu screen 631. The menu screen 631 includes a list of operations that can be executed on the file being displayed. The executable operations include “print” 632.

In response to the user selecting “print” 632 on the screen 630, the application 502 requests the print job control unit 506 to print the file selected by the user (in this example, the file being displayed). Since the file selected by the user is encrypted, the print job control unit 506 displays a screen 640 that includes a password input screen 641.

In response to the user inputting the password for the file 601 on the password input screen 641 and pressing the OK button, the print job control unit 506 generates plaintext data by decrypting the file 601 using the encryption/decryption processing unit 504. Subsequently, the print job control unit 506 generates a raster image showing the content of the plaintext data, and displays a screen 650 that includes a portion of the raster image as a preview 651.

In response to the user pressing “select printer” 652 on the screen 650, the print job control unit 506 displays a screen 660 that includes a list 661 of available printing devices. The printing devices displayed in the list 661 may be printing devices determined to be available as a result of a network search performed by the printing device management unit 507, or may be printing devices that have been registered in advance in the user device 103 by the user.

In response to the user selecting one of the printers in the list 661 (in the example shown in FIG. 6, a printer A), the print job control unit 506 displays a screen 670 indicating that the printer A was selected. In response to the user pressing “print” 671 on the screen 670, the print job control unit 506 generates a print job using the print job generation unit 508, and transmits the print job to the printing device 101. The print job control unit 506 also requests the printing device 101 to execute printing in accordance with the print job. Details of the printing sequence will be described later.

### Example of Operation of User Device

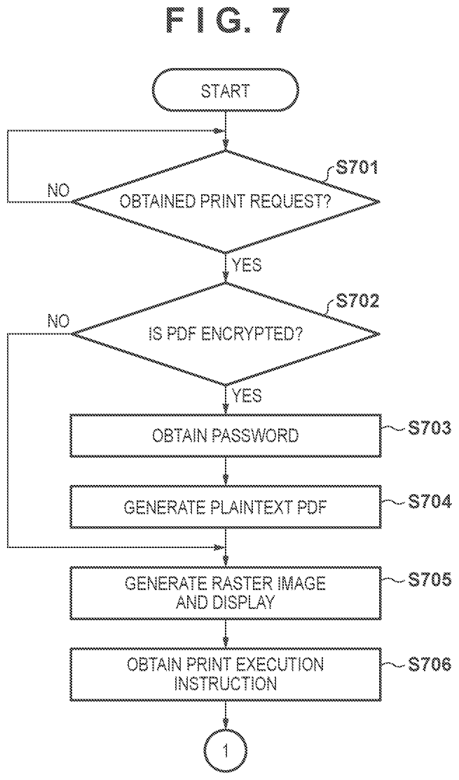

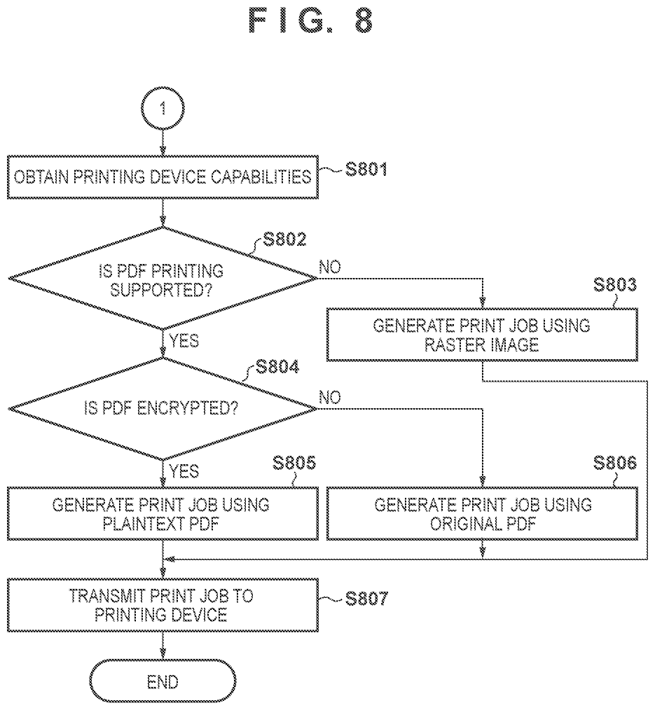

An example of operations of the user device 103 will be described below with reference to FIGS. 7 and 8. The operations shown in FIG. 7 may be started in response to, for example, the user device 103 being started up.

In step S701, the print job control unit 506 determines whether or not a print request has been obtained from the application 502. In the case of determining that a print request has been obtained (“YES” in step S701), the print job control unit 506 moves to the processing of step S702, or otherwise (“NO” in step S701), repeats the processing of step S701. In this way, the print job control unit 506 waits for a print request from the application 502. For example, as described above with reference to FIG. 6, the application 502 may request the print job control unit 506 to execute printing in response to receiving a print instruction from the user. The print request specifies data designated by the user as a print target (e.g., the file 601 selected on the screen 600). In the following description, a case will be described in which PDF data is designated as the print target by the user. If another type of data is designated, the print request may be processed as in conventional technology.

In step S702, the print job control unit 506 determines whether or not the print target PDF data is encrypted. In the case of determining that the print target PDF data is encrypted (“YES” in step S702), the print job control unit 506 moves to the processing of step S703, or otherwise (“NO” in step S702), moves to the processing of step S705. The print job control unit 506 may determine whether or not the PDF data is encrypted by analyzing the PDF data using the PDF processing unit 503.

In the case of determining that the print target PDF data is encrypted, the print job control unit 506 decrypts the encrypted PDF data by executing steps S703 and S704. In the case of determining that the PDF data is not encrypted, the print target PDF data is plaintext PDF data, and thus there is no need for decryption.

In step S703, the print job control unit 506 obtains a password for the encrypted PDF data. The print job control unit 506 may obtain the password from the user through the password input screen 641 in FIG. 6, for example. Alternatively, the print job control unit 506 may obtain the password obtained by the application 502 from the user through the password input screen 611.

In step S704, the print job control unit 506 decrypts the encrypted PDF data by providing the password and the encrypted PDF data to the encryption/decryption processing unit 504. Plaintext PDF data is thus generated.

In step S705, the print job control unit 506 generates a raster image for preview by providing the plaintext PDF data to the display data generation unit 505, and displays part of the raster image as a preview on the operation unit 407 of the user device 103.

In step S706, the print job control unit 506 obtains a print execution instruction from the user. For example, the print job control unit 506 may interpret pressing of “print” 671 on the screen 670 by the user as a print execution instruction. If the print job control unit 506 does not obtain a print execution instruction from the user (e.g., if the user pressed “cancel” on the screen 670), the print job control unit 506 moves to the processing of step S701 and waits for a new print request.

Next, in step S801 of FIG. 8, the print job control unit 506 obtains the capabilities of the printing device designated by the user (hereinafter considered to be the printing device 101). The capabilities of the printing device 101 may be obtained by transmitting an inquiry to the printing device 101 at the time, may be obtained by reading the result of a past inquiry from the storage 404 of the user device 103, or may be acquired by another method.

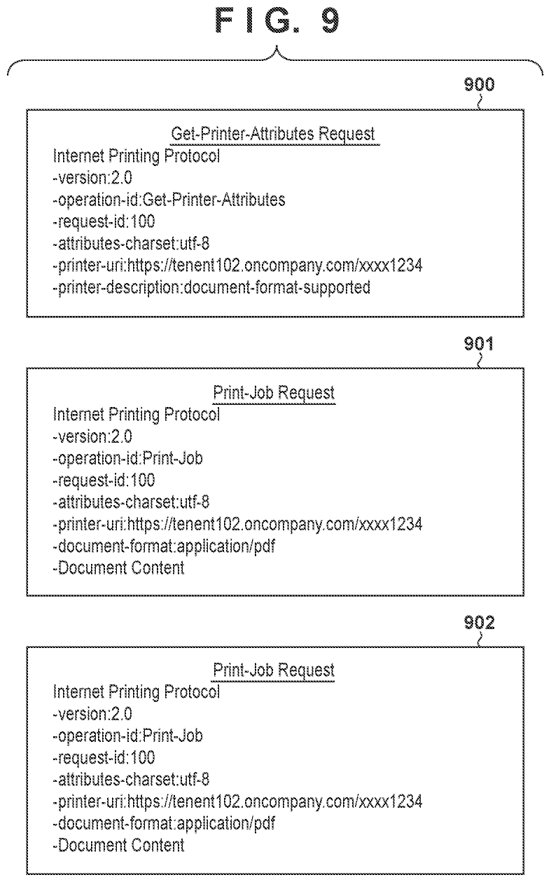

The inquiry made to the printing device 101 may be made using the IPP-compliant Get-Printer-Attributes operation. A message 900 in FIG. 9 is an example of a message transmitted by the Get-Printer-Attributes operation. Parameters that may be related to the present embodiment are described in the message 900. “operation-id: Get-Printer-Attributes” indicates the ID of the operation. “printer-description: document-format-supported” indicates making an inquiry regarding “supported document formats” to the printing device 101. If “application/pdf” is included in the response to the Get-Printer-Attributes operation, the printing device 101 is capable of executing PDF printing.

In step S802, the print job control unit 506 determines whether or not the printing device 101 supports PDF printing. In the case of determining that the printing device 101 supports PDF printing (“YES” in step S802), the print job control unit 506 moves to the processing of step S804, or otherwise (“NO” in step S802), moves to the processing of step S803. The print job control unit 506 may make the determination in step S802 based on the capabilities of the printing device 101 obtained in step S801.

In step S804, the print job control unit 506 determines whether or not the print target PDF data is encrypted. In the case of determining that the PDF data is encrypted (“YES” in step S804), the print job control unit 506 moves to the processing of step S805, or otherwise (“NO” in step S804), moves to the processing of step S806.

In the case of determining that the printing device 101 does not support PDF printing, in step S803, the print job control unit 506 generates a print job using a raster image showing the PDF data. The raster image used in step S803 may be the raster image generated in step S705.

In the case of determining that the printing device 101 supports PDF printing, and also determining that the PDF data is encrypted, in step S805, the print job control unit 506 generates a print job using plaintext PDF data. The plaintext PDF data used in step S805 may be the plaintext PDF data generated in step S704.

In the case of determining that the printing device 101 supports PDF printing, and also determining that the PDF data is not encrypted, in step S806, the print job control unit 506 generates a print job using print target PDF data. In this case, the print target PDF data is a plaintext PDF file.

In step S807, the print job control unit 506 transmits the print job generated in step S803, S805, or S806 to the printing device 101, and requests the printing device 101 to execute printing in accordance with the print job. The print request may be made using the IPP-compliant Print-Job operation.

Messages 901 and 902 in FIG. 9 are examples of messages transmitted by the Print-Job operation. Parameters that may be related to the present embodiment are described in the messages 901 and 902. “operation-id: Print-Job” indicates the ID of the operation. “document-format” indicates the format of the document included in the print job. In the case of transmitting the print job generated in step S805 or S806 to the printing device 101, the print job control unit 506 designates “application/pdf” as the “document-format”, as in the message 901. In the case of transmitting the print job generated in step S803 to the printing device 101, the print job control unit 506 designates “image/urf” as the “document-format”, as in the message 902. Instead of “image/urf”, “image/bmp”, “image/jpeg”, or the like may be designated depending on the type of raster image.

According to the present embodiment, when the user device 103 obtains plaintext PDF data from the user as a print target, the user device 103 transmits the plaintext PDF data to the printing device 101 as print data. On the other hand, when the user device 103 obtains encrypted PDF data from the user as a print target, instead of transmitting the encrypted PDF data to the printing device 101, the user device 103 transmits plaintext PDF data to the printing device 101. If the encrypted PDF data is transmitted to the printing device 101, the printing device 101 transmits an “unprintable error” notification to the user device 103 due to not being able to decrypt the PDF data. In response to this error, the printing device 101 may convert the encrypted PDF data into a raster image and retransmit a print job that includes the raster image. However, if the printing device 101 cannot receive the error notification (e.g., if the power is turned off after the print execution instruction is given), printing fails. Also, if the printing device does not have a function for transmitting an “unprintable error” notification when not able to process encrypted PDF data, or if the encrypted PDF data cannot be processed due to hold printing being designated, the user device 103 cannot immediately retransmit the print job. According to the present embodiment, instead of encrypted PDF data being transmitted to the printing device 101, plaintext PDF data is transmitted to the printing device 101, thus making it possible to efficiently execute printing of the encrypted PDF data regardless of timing or environment. Furthermore, since the plaintext PDF data obtained by decryption is the of same data type as the encrypted PDF data (both are PDF data), printing can be executed more efficiently than in the case of re-executing printing using a raster image as print data.

In the first embodiment, the printing device 101 operates as a processing apparatus that processes print data. The processing of print data performed by the printing device 101 may be the printing of the print data. Also, in the first embodiment, the user device 103 operates as a transmission apparatus that transmits print data to a processing apparatus (i.e., the printing device 101). The user device 103 may obtain a designation of a print target (e.g., a designation of encrypted PDF data or plaintext PDF data) from the user.

### Second Embodiment

In the first embodiment, the user device 103 directly causes the printing device 101 to execute printing (i.e., without using a printing service provided by the print server 102). In a second embodiment, a case will be described in which the user device 103 uses a printing service provided by the print server 102. In the description of the second embodiment, redundant descriptions will not be given for matter that may be similar to that in the first embodiment.

### Example of Software Configuration of Print Server

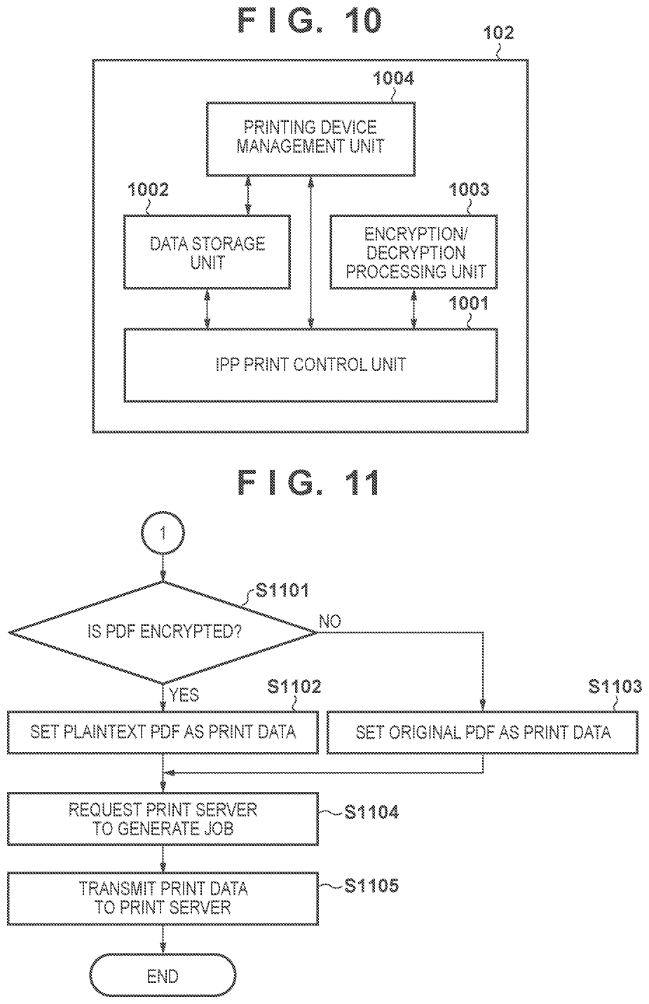

An example of the software configuration of the print server 102 will be described below with reference to FIG. 10. The print server 102 may include the constituent elements shown in FIG. 10. The print server 102 may not include some of the constituent elements shown in FIG. 10, and may include constituent elements not shown in FIG. 10. The constituent elements (i.e., functional blocks) shown in FIG. 10 may be realized by the CPU 201 of the print server 102 executing a program loaded to the RAM 203 of the print server 102.

An IPP print control unit 1001 has a function of controlling communication with the user device 103 and the printing device 101 when performing IPP-related printing and printing device management. A data storage unit 1002 has a function of storing print data received from the user device 103 in the storage 204 of the print server 102. An encryption/decryption processing unit 1003 has a function of decrypting encrypted PDF data. A printing device management unit 1004 has a function of registering and deregistering the printing device 101. The print server 102 may further include an authentication management unit that manages authentication information with respect to users and printing devices, a UI control unit that performs various types of setting related to a cloud service, and the like.

Communication between the print server 102 and the printing device 101 may be performed using conventional technology. For example, communication may be performed using operations defined in PWG 5100.12-2015, which is an extension of IPP.

### Example of Operation of User Device

An example of operations of the user device 103 will be described below with reference to FIGS. 7 and 11. The operations in FIGS. 7 and 11 may be started in response to, for example, the user device 103 being started up. The operations in FIG. 7 may be similar to those in the first embodiment, and thus redundant descriptions will not be given for such operations.

In step S1101, the print job control unit 506 determines whether or not the print target PDF data is encrypted. In the case of determining that the PDF data is encrypted (“YES” in step S1101), the print job control unit 506 moves to the processing of step S1102, or otherwise (“NO” in step S1101), moves to the processing of step S1103.

In the case of determining that the PDF data is encrypted, in step S1102, the print job control unit 506 sets plaintext PDF data as print data. Print data can also be called printing data or document data. The plaintext PDF data used in step S1102 may be the plaintext PDF data generated in step S704.

In the case of determining that the PDF data is not encrypted, in step S1103, the print job control unit 506 sets the print target PDF data as print data. In this case, the print target PDF data is a plaintext PDF file.

In step S1104, the print job control unit 506 requests the print server 102 to generate a print job, and receives a response to the request. The request only requests the generation of a print job for managing a job attribute and a job ID, and does not need to include print data. This request may be made by the IPP-compliant Create-Job operation. The Create-Job operation is an operation for requesting only the generation of a print job. The Create-Job operation may designate a job attribute.

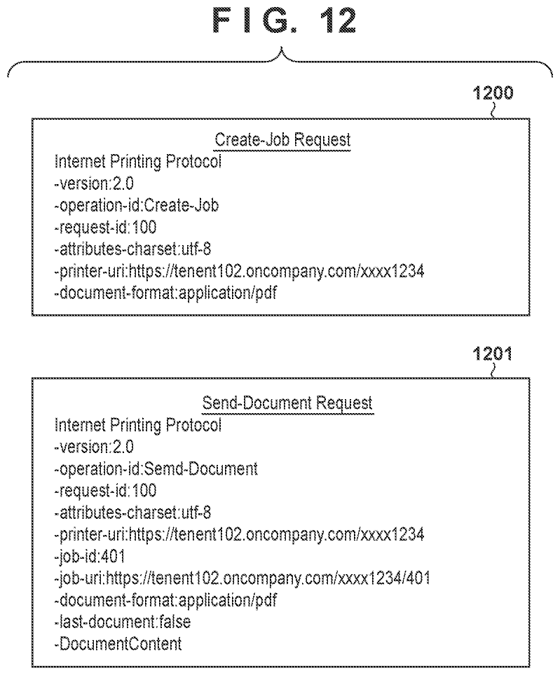

A message 1200 in FIG. 12 is an example of a message transmitted by the Create-Job operation. Parameters that may be related to the present embodiment are described in the message 1200. “document-format” indicates the document format of print data. When the document format is PDF, the print job control unit 506 designates “application/pdf” as the “document-format”, as in the message 1200.

In step S1105, the print job control unit 506 transmits the print data set in step S1102 or S1103 to the print server 102, and receives a response to the transmission. Transmission of the print data may be performed using the IPP-compliant Send-Document operation. The Send-Document operation is an operation for transmitting print data that was generated by the Create-Job operation and is to be included in a print job.

A message 1201 in FIG. 12 is an example of a message transmitted by the Send-Document operation. Parameters that may be related to the present embodiment are described in the message 1201. “document-format” indicates the document format of print data. When the document format is PDF, the print job control unit 506 designates “application/pdf” as the “document-format”, as in the message 1201. “DocumentContent” indicates the print data that is to be transmitted.

Thereafter, using conventional technology for example, the print server 102 transmits a print job that includes the print data received from the user device 103 to the printing device 101, and causes the print data to be printed.

According to the present embodiment, in the case where plaintext PDF data was obtained from the user as a print target, the user device 103 transmits the plaintext PDF data to the print server 102 as print data. On the other hand, in the case where encrypted PDF data was obtained from the user as a print target, instead of transmitting the encrypted PDF data to the print server 102, the user device 103 transmits plaintext PDF data to the print server 102 as print data. In the case where a print job that includes encrypted PDF data is transmitted to the print server 102, the printing device 101 that receives the print instruction from the print server 102 cannot decrypt the PDF data. If the print server 102 cannot correctly recognize the cause of the error in the printing device 101, the user device 103 cannot retransmit the print job. According to the present embodiment, instead of encrypted PDF data being transmitted to the print server 102, plaintext PDF data is transmitted to the print server 102, thus making it possible to efficiently print encrypted PDF data regardless of timing or environment.

In the second embodiment, the print server 102 operates as a processing apparatus that processes print data. The processing of print data performed by the print server 102 may include instructing the printing device 101 to print the print data. Furthermore, in the second embodiment, the user device 103 operates as a transmission apparatus that transmits print data to a processing apparatus (i.e., the printing device 101). The user device 103 may obtain a designation of a print target (e.g., a designation of encrypted PDF data or plaintext PDF data) from the user.

In the second embodiment, instead of the user device 103 executing steps S1101 to S1103, after step S1105, the print server 102 may execute processing similar to steps S801 to S807. The user device 103 may transmit the print target data to the print server 102 in step S1105. In this variation, the printing device 101 operates as a processing apparatus that processes print data. The processing of print data performed by the printing device 101 may be the printing of the print data. Furthermore, in this variation, the print server 102 operates as a transmission apparatus that transmits print data to a processing apparatus (i.e., the printing device 101).

### Third Embodiment

In the first embodiment, when an instruction to print encrypted PDF data is received from the user, the user device 103 decrypts the PDF data. In a third embodiment, instead of the user device 103 decrypting the PDF data, the user device 103 notifies the printing device 101 of the password of the encrypted PDF data such that the printing device 101 can decrypt the encrypted PDF data. In the description of the third embodiment, redundant descriptions will not be given for matter that may be similar to that in the first embodiment.

### Example of Operation of User Device

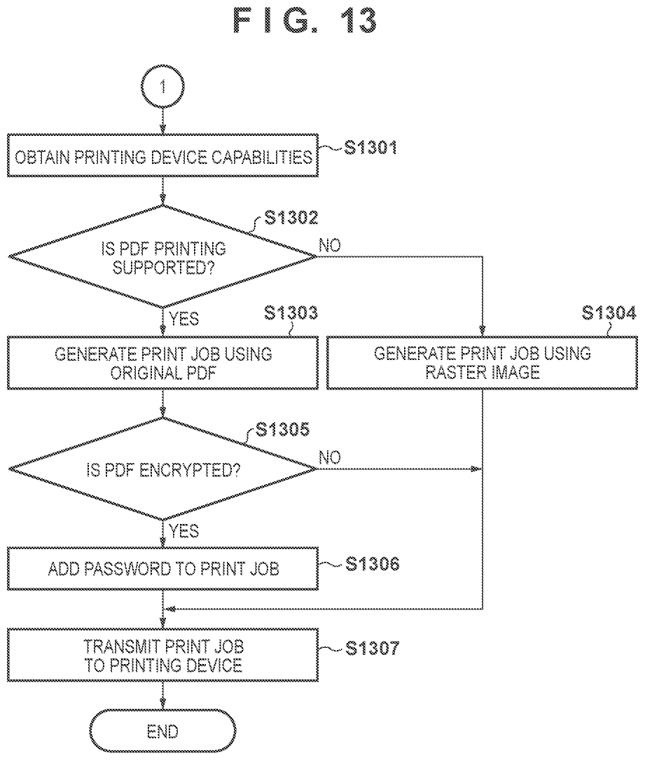

An example of operations of the user device 103 will be described below with reference to FIGS. 7 and 13. The operations in FIGS. 7 and 13 may be started in response to, for example, the user device 103 being started up. The operations in FIG. 7 may be similar to those in the first embodiment, and thus redundant descriptions will not be given for such operations.

In step S1301, similarly to step S801, the print job control unit 506 obtains the capabilities of a printing device designated by the user (hereinafter considered to be the printing device 101). In step S1302, similarly to step S802, the print job control unit 506 determines whether or not the printing device 101 supports PDF printing. In the case of determining that the printing device 101 supports PDF printing (“YES” in step S1302), the print job control unit 506 moves to the processing of step S1303, or otherwise (“NO” in step S1302), moves to the processing of step S1304.

In the case of determining that the printing device 101 supports PDF printing, in step S1303, the print job control unit 506 generates a print job using the print target PDF data. This PDF data may be encrypted PDF data or a plaintext PDF file.

In the case of determining that the printing device 101 does not support PDF printing, in step S1304, the print job control unit 506 generates a print job using a raster image showing the PDF data, similarly to step S803.

In step S1305, the print job control unit 506 determines whether or not the print target PDF data is encrypted, similarly to step S804. In the case of determining that the PDF data is encrypted (“YES” in step S1305), the print job control unit 506 moves to the processing of step S1306, or otherwise (“NO” in step S1305), moves to the processing of step S1307.

In step S1306, the print job control unit 506 adds a password for decrypting the print target PDF data to the print job generated in step S1303. The print job control unit 506 may add the password obtained in step S703 to the print job.

In step S1307, similarly to step S807, the print job control unit 506 transmits the print job generated in step S1303 or S1304 to the printing device 101, and requests the printing device 101 to execute printing in accordance with the print job. If a password was added to the print job in step S1306, the print job control unit 506 transmits the print job that includes the password to the printing device 101.

In step S1306 described above, the password may be added to the print job in any manner. For example, the password may be added to the header portion of the IPP protocol, or may be added to any area of an IPP-compliant operation.

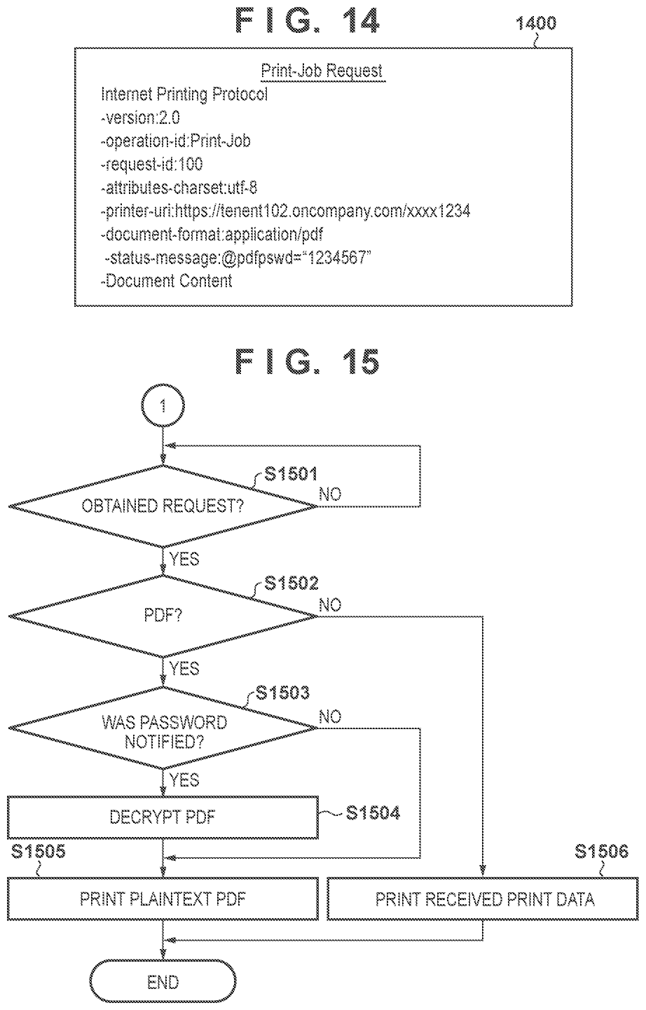

A message 1400 in FIG. 14 is an example of a message transmitted by the Print-Job operation. Parameters that may be related to the present embodiment are described in the message 1400. The message 1400 differs from the message 901 in that it includes a “status-message” area, but may be the same in other respects. The password for decrypting the print data (i.e., the encrypted PDF data) has been added to the “status-message” area.

In the above example, a password is added to the message 1400 for transmitting print data. The password may be notified to printing device 101 in another way. For example, the user device 103 may notify the printing device 101 of the password using a message different from an IPP-defined message.

### Example of Operation of Printing Device

An example of operations of the printing device 101 will be described below with reference to FIG. 15. The operations in FIG. 15 may be started in response to, for example, the printing device 101 being started up.

In step S1501, the print job generation unit 301 determines whether or not a print request has been obtained from the user device 103. In the case of determining that a print request has been obtained (“YES” in step S1501), the print job generation unit 301 moves to the processing of step S1502, or otherwise (“NO” in step S1501), repeats the processing of step S1501. In this way, the print job generation unit 301 waits for a print request from the user device 103. The print request includes print data designated as a print target by the user. This print data may be encrypted PDF data, or may be plaintext PDF data.

In step S1502, the print job generation unit 301 determines whether or not the print data is PDF data. In the case of determining that the print data is PDF data (“YES” in step S1502), the print job generation unit 301 moves to the processing of step S1503, or otherwise (“NO” in step S1502), moves to the processing of step S1506. The determination of whether or not the print data is PDF data may be made using the data reception control unit 302.

In step S1503, the print job generation unit 301 determines whether or not a password for decrypting the PDF data has been notified. In the case of determining that the password has been notified (“YES” in step S1503), the print job generation unit 301 moves to the processing of step S1504, or otherwise (“NO” in step S1503), moves to the processing of step S1505. The determination of whether or not the password has been notified may be made using the data reception control unit 302. For example, the determination of whether or not a password has been notified may be made based on whether or not a password has been added to the message for transmitting the print job that includes the print data (e.g., the message 1400).

In the case where it was determined that the print data is a PDF, and it was also determined that a password has been notified, in step S1504, the PDL analysis unit 306 decrypts the encrypted PDF data by providing the encrypted PDF data and the password to the encryption/decryption processing unit 308. Plaintext PDF data is thus generated. Thereafter, in step S1505, the job control unit 303 prints the plaintext PDF data as print data.

In the case where it was determined that the print data is a PDF, and it was also determined that a password has not been notified, in step S1505, the job control unit 303 prints the print data. Since a password has not been notified, the print data is plaintext PDF data.

In the case where it was determined that the print data is not PDF data, in step S1506, the job control unit 303 prints the print data using a method that corresponds to the type of print data. The printing of data other than PDF data may be executed using conventional technology.

According to the present embodiment, the user device 103 notifies the printing device 101 of the password, thus making it possible to efficiently print encrypted PDF data regardless of timing or environment.

In the third embodiment, the printing device 101 operates as a processing apparatus that processes print data. The processing of print data performed by the printing device 101 may be the printing of the print data. Furthermore, in the third embodiment, the user device 103 operates as a transmission apparatus that transmits print data to a processing apparatus (i.e., the printing device 101). The user device 103 may obtain a designation of a print target (e.g., a designation of encrypted PDF data or plaintext PDF data) from the user.

### Fourth Embodiment

In the third embodiment, the user device 103 adds a password to a print job transmitted to the printing device 101. In a fourth embodiment, the user device 103 adds a password to a print request transmitted to the print server 102. In the description of the fourth embodiment, redundant descriptions will not be given for matter that may be similar to that in the first embodiment.

### Example of Operation of User Device

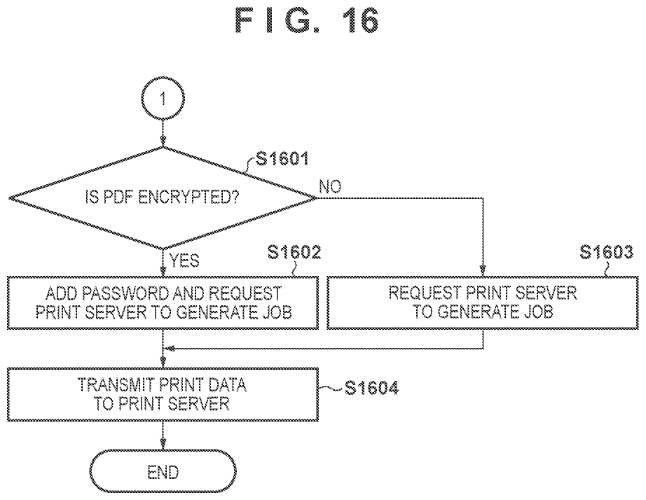

An example of operations of the user device 103 will be described below with reference to FIGS. 7 and 16. The operations in FIGS. 7 and 16 may be started in response to, for example, the user device 103 being started up. The operations in FIG. 7 may be similar to those in the first embodiment, and thus redundant descriptions will not be given for such operations.

In step S1601, similarly to step S1101, the print job control unit 506 determines whether or not the print target PDF data is encrypted. In the case of determining that the PDF data is encrypted (“YES” in step S1601), the print job control unit 506 moves to the processing of step S1602, or otherwise (“NO” in step S1601), moves to the processing of step S1603.

In the case of determining that the PDF data is encrypted, in step S1602, the print job control unit 506 requests the print server 102 to generate a print job, similarly to step S1104. Furthermore, the print job control unit 506 notifies the print server of a password for decrypting the print target PDF data. For example, the print job control unit 506 may add the password to a message for requesting the generation of a print job. The print job control unit 506 may add the password obtained in step S703 to the message. The password may be added to the header portion of the IPP protocol, or may be added to any area of an IPP-compliant operation (e.g., the Create-Job operation).

In the case of determining that the PDF data is not encrypted, in step S1603, the print job control unit 506 requests the print server 102 to generate a print job, similarly to step S1104. In this case, a password is not notified.

In step S1604, similarly to step S1105, the print job control unit 506 transmits the print target PDF data as print data to the print server 102. This PDF data may be encrypted PDF data or plaintext PDF data.

In the above example, the user device 103 adds the password to the print job generation request transmitted in step S1602. Alternatively, the user device 103 may add the password to the message that includes the print data transmitted in step S1604 (e.g., the message transmitted in the Send-Document operation), or notify the print server 102 of the password using another method.

### Example of Operation of Print Server

Upon receiving a password from the user device 103 with the print job generation request or in another manner, the print server 102 notifies the printing device 101 of the password. For example, the print server 102 generates a print job to which the password has been added, and transmits the print job to the printing device 101. The print job may be generated through processing similar to that in step S1306 of FIG. 3, and therefore a redundant description will not be given for such processing. If the print data included in the print job is encrypted PDF data, the password for decrypting the encrypted PDF data is added to the print job.

### Example of Operation of Printing Device

The printing device 101 executes printing in accordance with the print job received from the print server 102. The printing device 101 may obtain the print job from the print server 102 using conventional technology. The operations of the printing device 101 after obtaining the print job may be similar to the operations of the printing device 101 in the third embodiment, and therefore a redundant description will not be given for such operations.

According to the present embodiment, the user device 103 notifies the print server 102 of the password, thus making it possible to efficiently print encrypted PDF data regardless of timing or environment.

In the fourth embodiment, the printing device 101 and the print server 102 both operate as a processing apparatus that processes print data. The processing of print data performed by the printing device 101 may be the printing of the print data. The processing of print data performed by the print server 102 may be the generation of a print job that includes the print data. Also, the user device 103 and the print server 102 both operate as a transmission apparatus that transmits print data to a processing apparatus (i.e., the print server 102 or the printing device 101).

### Fifth Embodiment

In the third embodiment, the user device 103 determines whether or not print data is encrypted by analyzing the print data. In a fifth embodiment, the user device 103 determines whether or not print data is encrypted based on a response from the printing device 101. In the description of the fifth embodiment, redundant descriptions will not be given for matter that may be similar to that in the third embodiment.

### Example of Operation of User Device

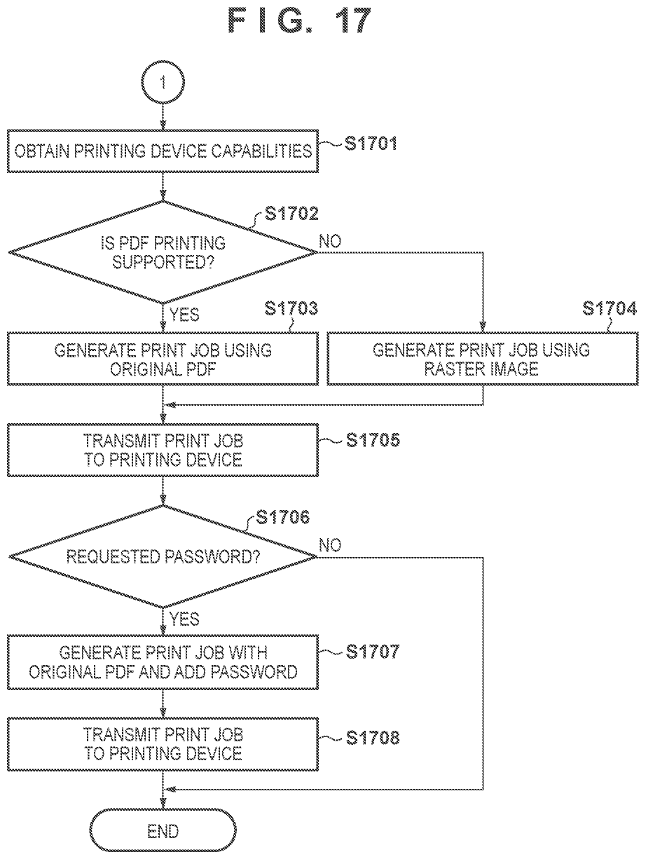

An example of operations of the user device 103 will be described below with reference to FIGS. 7 and 17. The operations in FIGS. 7 and 17 may be started in response to, for example, the user device 103 being started up. The operations in FIG. 7 may be similar to those in the first embodiment, and thus redundant descriptions will not be given for such operations.

In step S1701, similarly to step S1301, the print job control unit 506 obtains the capabilities of a printing device designated by the user (hereinafter considered to be the printing device 101). In step S1702, similarly to step S1302, the print job control unit 506 determines whether or not the printing device 101 supports PDF printing. In the case of determining that the printing device 101 supports PDF printing (“YES” in step S1702), the print job control unit 506 moves to the processing of step S1703, or otherwise (“NO” in step S1702), moves to the processing of step S1704.

In the case of determining that the printing device 101 supports PDF printing, in step S1703, the print job control unit 506 generates a print job using the print target PDF data, similarly to step S1303. This PDF data may be encrypted PDF data or a plaintext PDF file.

In the case of determining that the printing device 101 does not support PDF printing, in step S1704, the print job control unit 506 generates a print job using a raster image showing the PDF data, similarly to step S1304.

In step S1705, similarly to step S1307, the print job control unit 506 transmits the print job generated in step S1703 or S1704 to the printing device 101, and requests the printing device 101 to execute printing in accordance with the print job.

In step S1706, the print job control unit 506 determines whether or not the printing device 101 has requested a password for decrypting the print data. In the case of determining that a password has been requested by the printing device 101 (“YES” in step S1706), the print job control unit 506 moves to the processing of step S1707, or otherwise (“NO” in step S1706), ends the processing.

In step S1707, similarly to steps S1303 and S1306, the print job control unit 506 generates a print job using the print target PDF data, and adds a password to the print job. In step S1708, similarly to step S1307, the print job control unit 506 transmits the print job generated in step S1707 to the printing device 101, and requests the printing device 101 to execute printing in accordance with the print job. Similarly to the third embodiment, the password may be notified to the printing device 101 in another way.

### Example of Operation of Printing Device

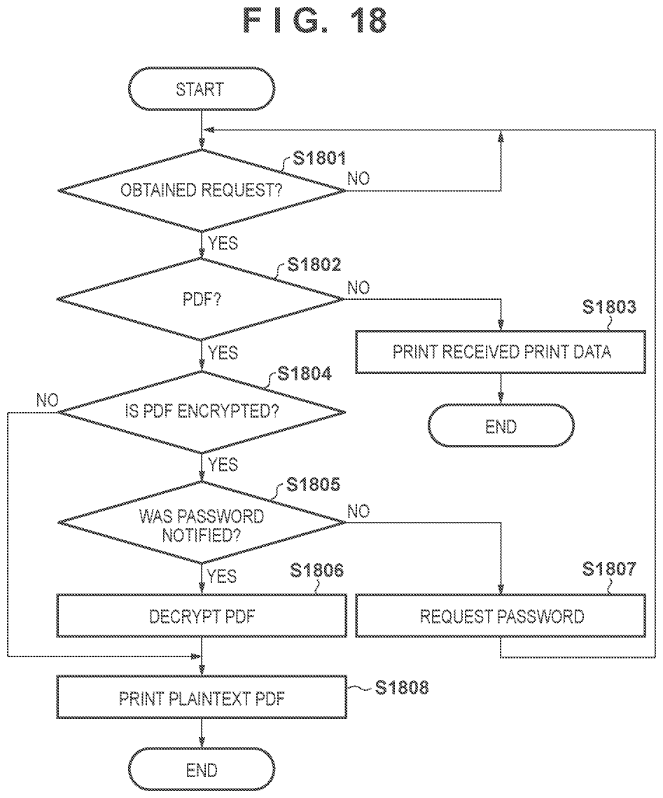

An example of operations of the printing device 101 will be described below with reference to FIG. 18. The operations in FIG. 18 may be started in response to, for example, the printing device 101 being started up.

In step S1801, similarly to step S1501, the print job generation unit 301 determines whether or not a print request has been obtained from the user device 103. In the case of determining that a print request has been obtained (“YES” in step S1801), the print job generation unit 301 moves to the processing of step S1802, or otherwise (“NO” in step S1801), repeats the processing of step S1801. In this way, the print job generation unit 301 waits for a print request from the user device 103. The print request includes print data designated as a print target by the user. This print data may be encrypted PDF data, or may be plaintext PDF data.

In step S1802, similarly to step S1502, the print job generation unit 301 determines whether or not the print data is PDF data. In the case of determining that the print data is PDF data (“YES” in step S1802), the print job generation unit 301 moves to the processing of step S1804, or otherwise (“NO” in step S1802), moves to the processing of step S1803. The determination of whether or not the print data is PDF data may be made using the data reception control unit 302.

In the case of determining that the print data is not PDF data, in step S1803, the job control unit 303 prints the print data using a method that corresponds to the type of the print data. The printing of data other than PDF data may be executed using conventional technology.

In step S1804, the print job generation unit 301 determines whether or not the print target PDF data is encrypted. In the case of determining that the PDF data is encrypted (“YES” in step S1804), the print job generation unit 301 moves to the processing of step S1805, or otherwise (“NO” in step S1804), moves to the processing of step S1808.

In step S1805, similarly to step S1503, the print job generation unit 301 determines whether or not a password for decrypting the PDF data has been notified. In the case of determining that a password has been notified (“YES” in step S1805), the print job generation unit 301 moves to the processing of step S1806, or otherwise (“NO” in step S1805), moves to the processing of step S1807. The determination of whether or not the password has been notified may be made using the data reception control unit 302.

In step S1806, the PDL analysis unit 306 decrypts the encrypted PDF data by providing the encrypted PDF data and the password to the encryption/decryption processing unit 308. Plaintext PDF data is thus generated. Thereafter, in step S1505, the job control unit 303 prints the plaintext PDF data as print data.

In the case of determining that a password has not been notified, the print job generation unit 301 requests a password from the user device 103 in step S1807. For example, as the request, the print job generation unit 301 may notify the user device 103 that the print data cannot be decrypted because the password has not been notified.

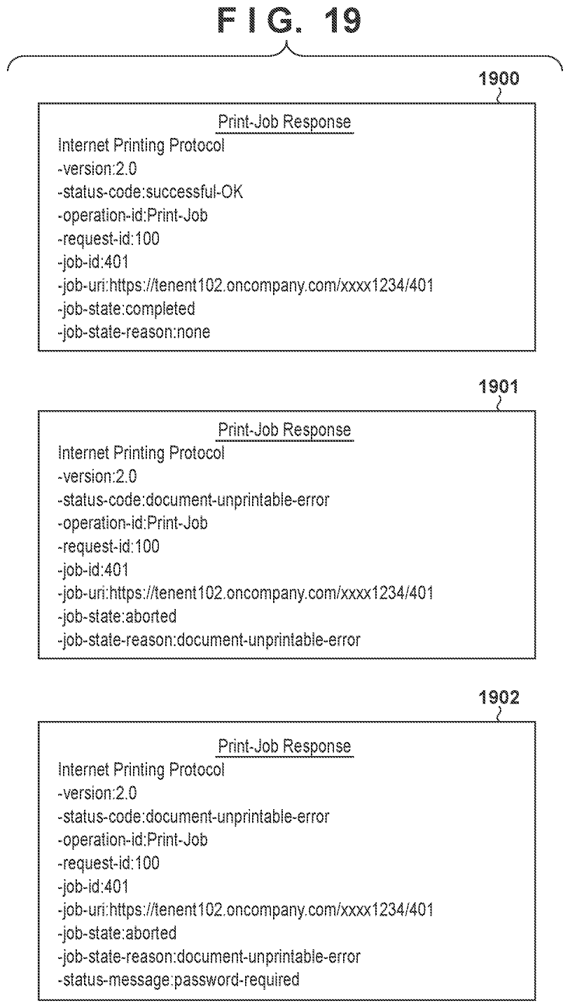

The password request may be made using the IPP-compliant Print-Job operation. Messages 1900 to 1902 in FIG. 19 are examples of messages given as a response in the Print-Job operation. Parameters that may be related to the present embodiment are described in the messages 1900 to 1902. In order to request a password, the print job generation unit 301 may designate “password-required” in “status-message”, as in the message 1902. Additionally, in order to indicate that printing has failed, the print job generation unit 301 may designate “document-unprintable-error” in “status-code”, as in the messages 1901 and 1902. In order to indicate that printing was successful, the print job generation unit 301 may designate “successful-OK” in “status-code”, as in the message 1900. Alternatively, a password request may be designated in the header portion of the IPP protocol or in an optional field of an IPP-compliant operation.

The printing device 101 may operate in a hold print mode. In this case, the printing device 101 executes the print request obtained in step S1801 by hold printing. Hold printing is a function in which, when the printing device 101 receives a print job, instead of immediately starting printing in accordance with the print job, the start of printing of the print data is suspended until the user gives an instruction to start printing. The instruction to start printing may be issued by operating the operation unit 206 of the printing device 101. If hold printing is designated, the printing device 101 may wait to receive an instruction to start printing from the user in steps S1803 and S1808. In this case as well, in step S1807, the printing device 101 requests a password from the user device 103 before receiving an instruction to start the printing of the encrypted PDF data. The user device 103 can thus notify the printing device 101 of the password in step S1707.

According to the present embodiment, even if printing of the received print job is not executed immediately due to, for example, the printing device 101 operating in the hold print mode, it is possible to obtain the password of the encrypted PDF data. This makes it possible to efficiently print encrypted PDF data.

### Sixth Embodiment

In the fourth embodiment, the user device 103 determines whether or not print data is encrypted by analyzing the print data. In a sixth embodiment, the user device 103 determines whether or not print data is encrypted based on a response from the print server 102. In the description of the sixth embodiment, redundant descriptions will not be given for matter that may be similar to that in the fourth embodiment.

### Example of Operation of User Device

Operations of the user device 103 may be similar to operations of the user device 103 in the fifth embodiment. In the sixth embodiment, instead of transmitting a print job to the printing device 101, the user device 103 transmits print target print data to the print server 102. In step S1706, the user device 103 determines whether or not a password has been requested by the print server 102. In the case where a password has been requested, the user device 103 may cancel the requested print job and again request generation of the print job in step S1707.

### Example of Operation of Print Server

Upon receiving print data from the user device 103, the print server 102 may execute processing similar to that in steps S1802 to S1807. Specifically, if the print data is encrypted and the password for decrypting the print data has not been notified, the print server 102 may request the password from the user device 103, similarly to step S1807. The password may be requested before the print server 102 transmits the print job to the printing device 101. Accordingly, the user device 103 can immediately transmit the password to the print server 102.

According to the present embodiment, even in the case where the print server 102 receives a print request from the user device 103, the print server 102 can obtain the password of encrypted PDF data. This makes it possible to efficiently print encrypted PDF data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-060440, filed Apr. 3, 2023, which is hereby incorporated by reference herein in its entirety.

What is claimed is:

1. A transmission apparatus for transmitting print data to a processing apparatus that processes the print data, the transmission apparatus comprising:
a decryption unit configured to generate plaintext data by decrypting encrypted data designated as a print target by a user; and
a transmission unit configured to transmit the plaintext data to the processing apparatus as the print data, without transmitting the encrypted data to the processing apparatus.

2. The transmission apparatus according to claim 1,
wherein the transmission unit is further configured to transmit second plaintext data to the processing apparatus as second print data, the second plaintext data being designated as a second print target by the user.

3. The transmission apparatus according to claim 1,
wherein the plaintext data is data of the same type as the encrypted data.

4. The transmission apparatus according to claim 1,
wherein the transmission unit transmits the plaintext data to the processing apparatus in a message compliant with Internet Printing Protocol (IPP).

5. The transmission apparatus according to claim 1,
wherein the transmission apparatus is a user device that obtains the designation of the print target from the user, and
the processing apparatus is a printing device that prints the print data.

6. The transmission apparatus according to claim 1,
wherein the transmission apparatus is a user device that obtains the designation of the print target from the user, and
the processing apparatus is a print server that instructs a printing device to print the print data.

7. A transmission apparatus for transmitting print data to a processing apparatus that processes the print data, the transmission apparatus comprising:
a transmission unit configured to transmit encrypted data designated as a print target by a user to the processing apparatus as the print data; and
a notification unit configured to notify the processing apparatus of a password for decrypting the encrypted data.

8. The transmission apparatus according to claim 7,
wherein the notification unit adds the password to a message for transmitting the print data.

9. The transmission apparatus according to claim 7,
wherein the transmission unit transmits the encrypted data to the processing apparatus in a message compliant with IPP.

10. The transmission apparatus according to claim 7,
wherein the transmission apparatus is a user device that obtains the designation of the print target from the user, and
the processing apparatus is a printing device that prints the print data.

11. The transmission apparatus according to claim 7,
wherein the transmission apparatus is a user device that obtains the designation of the print target from the user, and
the processing apparatus is a print server that instructs a printing device to print the print data.

12. A non-transitory computer-readable storage medium having stored thereon a program for causing a computer to function as the transmission apparatus according to claim 1.

13. A processing apparatus for processing print data, comprising:
a reception unit configured to receive encrypted data designated as a print target by a user from a transmission apparatus;
a determination unit configured to determine whether or not a password for decrypting the encrypted data has been notified;
a decryption unit configured to, in a case where it is determined that the password has been notified, generate plaintext data by decrypting the encrypted data; and
a processing unit configured to process the plaintext data as the print data.

14. The processing apparatus according to claim 13, further comprising:
a request unit configured to, in a case where it is determined that the password has not been notified, request the password from the transmission apparatus.

15. The processing apparatus according to claim 14,
wherein in a case where it is designated that a start of printing of the encrypted data is to be suspended until an instruction to start printing is received, the request unit requests the password from the transmission apparatus before reception of the instruction to start printing of the encrypted data.

16. The processing apparatus according to claim 13,
wherein the reception unit receives the encrypted data from the transmission apparatus in a message compliant with IPP.

17. The processing apparatus according to claim 13,
wherein the transmission apparatus is a user device that obtains the designation of the print target from the user, and
the processing apparatus is a printing device that prints the print data.

18. The processing apparatus according to claim 13,
wherein the transmission apparatus is a user device that obtains the designation of the print target from the user, and
the processing apparatus is a print server that instructs a printing device to print the print data.

19. A non-transitory computer-readable storage medium having stored thereon a program for causing a computer to function as the processing apparatus according to claim 13.

20. A transmission method for transmitting print data to a processing apparatus that processes the print data, the transmission method comprising:
generating plaintext data by decrypting encrypted data designated as a print target by a user; and
transmitting the plaintext data to the processing apparatus as the print data, without transmitting the encrypted data to the processing apparatus.

21. A transmission method for transmitting print data to a processing apparatus that processes the print data, the transmission method comprising:
transmitting encrypted data designated as a print target by a user to the processing apparatus as the print data; and
notifying the processing apparatus of a password for decrypting the encrypted data.

22. A processing method for processing print data, comprising:
receiving encrypted data designated as a print target by a user from a transmission apparatus;
determining whether or not a password for decrypting the encrypted data has been notified;
generating, in a case where it is determined that the password has been notified, plaintext data by decrypting the encrypted data; and
processing the plaintext data as the print data.
